(19) United States
(12) Patent Application Publication
(10) Pub. No.: US 2013/0258539 A1
(43) Pub. Date: Oct. 3, 2013

(54) OVERVOLTAGE PROTECTION CIRCUIT AND ELECTRONIC DEVICE

(71) Applicants: TAO WANG, Shenzhen City (CN); XUE-BING DENG, Shenzhen City (CN); HAI-LONG CHENG, Shenzhen City (CN); XIAO-HUI MA, Shenzhen City (CN); HSING-SUANG KAO, Tu-Cheng (TW); XIN-PING LI, Shenzhen City (CN)

(72) Inventors: TAO WANG, Shenzhen City (CN); XUE-BING DENG, Shenzhen City (CN); HAI-LONG CHENG, Shenzhen City (CN); XIAO-HUI MA, Shenzhen City (CN); HSING-SUANG KAO, Tu-Cheng (TW); XIN-PING LI, Shenzhen City (CN)

(21) Appl. No.: 13/629,717

(22) Filed: Sep. 28, 2012

(30) Foreign Application Priority Data
Mar. 29, 2012 (CN) 201210087302.8

(51) Int. Cl. H02H 3/20

(52) U.S. Cl. 361/91.5; 361/91.1

(57) ABSTRACT

An electronic device powered by a voltage of a power supply includes a load, a switching module connected between the power supply and the load, and an overvoltage protection circuit. The overvoltage protection circuit comprises a control unit presetting a first predetermined voltage and an overvoltage protection unit. When the voltage is larger than the first predetermined voltage, the control unit generates a protection signal to control the overvoltage protection unit to generate a first control signal, the switching module cuts off an electrical connection between the power supply and the load in response to the first control signal.

### BACKGROUND

1. Technical Field

The present disclosure relates to electronic devices, particularly relates to an electronic device with an overvoltage protection circuit.

2. Description of Related Art

Electronic devices, such as mobile phones, are capable of being charged by a voltage generated by an engine of a car. When the engine of the car is started or the speed of the car is suddenly increased, the voltage of the engine can be larger than a normal working voltage of the electronic device, thus the electronic device may be damaged or destroyed by the voltage.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device in accordance with one embodiment.

FIG. 2 is a circuit diagram of the electronic device of FIG. 1 in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

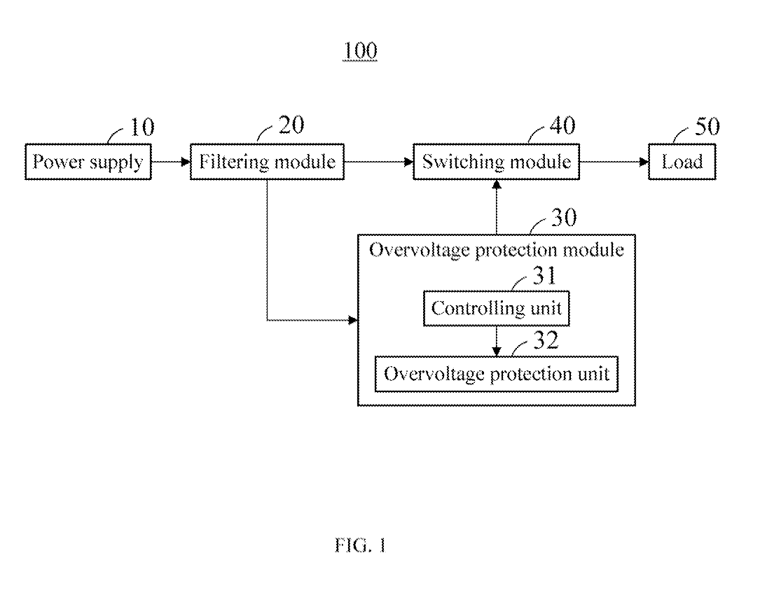

Referring to FIG. 1, an electronic device 100 of one embodiment of the present disclosure is shown. The electronic device 100 includes a power supply 10, a filtering module 20, an overvoltage protection circuit 30, a switching module 40, and a load 50. In the embodiment, the electronic device 100 can be a DVD player or TV in a car and powered by the car. In other embodiments, the electronic device 100 can be a mobile phone charged by the car.

The power supply 10 provides a voltage. In the embodiment, the power supply 10 is an engine of the car.

The filtering module 20 filters the voltage and outputs a filtered voltage to the overvoltage protection circuit 30 and the switching module 40.

The overvoltage protection circuit 30 is connected with the filtering module 20. The overvoltage protection circuit 30 includes a control unit 31 and an overvoltage protection unit 32.

The control unit 31 connected with the filtering module 20 presets a first predetermined voltage. The control unit 31 generates a protection signal to the overvoltage protection unit 32 when the filtered voltage is larger than the first predetermined voltage, and stops generating the protection signal when the filtered voltage is equal to or smaller than the first predetermined voltage. In the embodiment, the first predetermined voltage is 12V; the protection signal is a logic low level signal.

The overvoltage protection unit 32 connected with the filtering module 20 and the control unit 31 presets a second predetermined voltage which is smaller than the first predetermined voltage. When received the protection signal, the overvoltage protection unit 32 generates a first control signal in response to the protection signal. When the overvoltage protection unit 32 does not receive the protection signal and the filtered voltage is larger than or equal to the second predetermined voltage, the overvoltage protection unit 32 generates a second control signal. When the filtered voltage is smaller than the second predetermined voltage, the overvoltage protection unit 32 generates a first control signal when the filtered voltage is smaller than the second predetermined voltage. In the embodiment, the second predetermined voltage is larger than 0.7V; the first control signal is a logic high level signal, and the second control signal is a logic low level signal.

The switching module 40 cuts off the electrical connection between the filtering module 20 and the load 50 in response to the first control signal, and establishes the electrical connection between the filtering module 20 and the load 50 in response to the second control signal.

When the switching module 40 establishes the electrical connection between the filtering module 20 and the load 50, the load 50 receives the filtered voltage from the filtering module 20 through the switching module 40 and is being powered on to execute the corresponding function, such as music playing function, video playing function, for example.

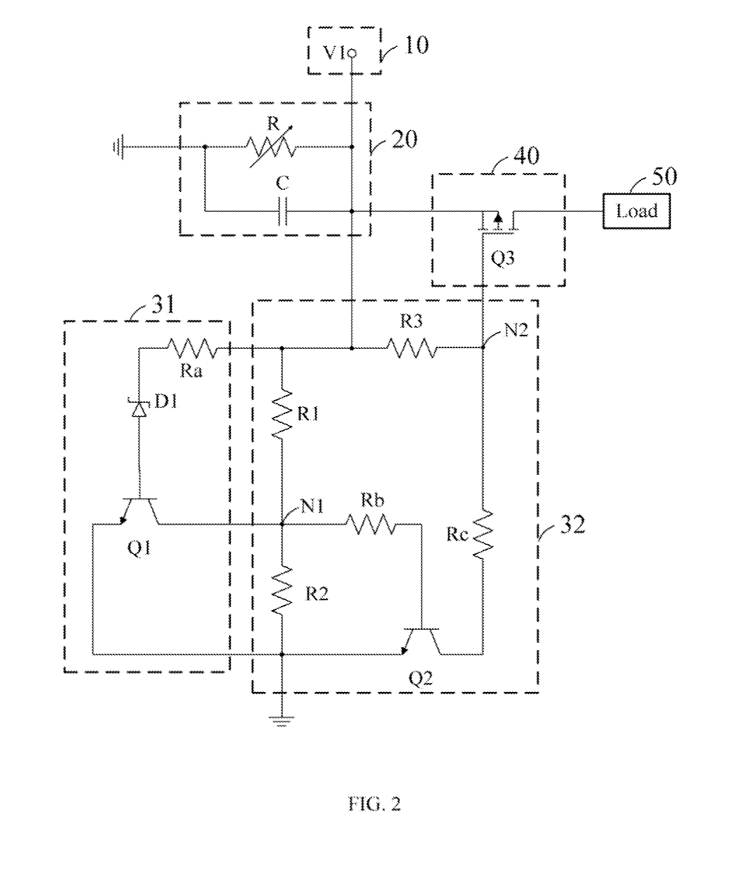

Referring to FIG. 2, the power supply 10 includes a power terminal V1 for providing the voltage.

The filtering module 20 includes an adjustable resistor R and a filtering capacitor C. An end of the adjustable resistor R is electrically connected to the power terminal V1, and the other end of the adjustable resistor R is grounded.

The control unit 31 includes a diode D1, a first transistor Q1, and a first protecting resistor Ra. A base of the first transistor Q1 is electrically connected to the power terminal V1 through the diode D1 and the first protecting resistor Ra. An emitter of the first transistor Q1 is grounded. A collector of the first transistor Q1 is electrically connected to the overvoltage protection unit 32. A cathode of the diode D1 is electrically connected to the power terminal V1 through the first protecting resistor Ra, and an anode of the diode D1 is electrically connected to the base of the first transistor Q1. In the embodiment, the first transistor Q1 is an npn type bipolar junction transistor, and the diode D1 is an avalanche diode or a zener diode.

The overvoltage protection unit 32 includes a second transistor Q2, a first resistor R1, a second resistor R2, a third resistor R3, a second protecting resistor Rb, a third protecting resistor Rc, a first node N1, and a second node N2. An end of the second resistor R2 is grounded, the other end of the second resistor R2 is electrically connected to the power terminal V1 through the first node N1 and the first resistor R1 in that order. A base of the second transistor Q2 is electrically connected to the first node N1 through the second protecting resistor Rb. An emitter of the second transistor Q2 is grounded. A collector of the second transistor Q2 is electrically connected to the power terminal V1 through the third protecting resistor Rc and the third resistor R3 in that order. The first node N1 is electrically connected to the collector of the first transistor Q1, and the second node N2 is electrically connected to the switching module 40. In the embodiment, the second transistor Q2 is an npn type bipolar junction transistor.

The switching module 40 includes a third transistor Q3. A gate of the third transistor Q3 is electrically connected to the second node N2. A source of the third transistor Q3 is electrically connected to the power terminal V1. A drain of the third transistor Q3 is electrically connected to the load 50. In the embodiment, the third transistor Q3 is a p-channel enhancement type metal oxide semiconductor field effect transistor.

When the voltage of the power terminal V1 is equal to or smaller than the first predetermined voltage, the difference in voltage of the anode and the cathode of the diode D1 is smaller than 0.7V and the diode D1 is turned off. The difference in voltage of the base and the emitter of the first transistor Q1 is smaller than 0.7V and the first transistor Q1 is turned off. When the voltage of the power terminal V1 is equal to or larger than the second predetermined voltage, the difference in voltage of the base and the emitter of the second transistor Q2 is larger than 0.7V, the second transistor Q2 is turned on and the voltage at second node N2 is pulled to be lower than the voltage of the power terminal V1. The difference in voltage of the source and the gate of the third transistor Q3 is smaller than 0V, and the third transistor Q3 is turned on. The voltage of the power terminal V1 is filtered by the capacitor C, and then the filtered voltage is outputted to the load 50. When the voltage of the power terminal V1 is smaller than the second predetermined voltage, the difference in voltage of the base and the emitter of the second transistor Q2 is smaller than 0.7V, the second transistor Q2 is turned off and the voltage at second node N2 is equal to the voltage of the power terminal V1. The difference in voltage of the source and the gate of the third transistor Q3 is equal to 0V, and the third transistor Q3 is turned off. The voltage of the power terminal V1 is filtered by the capacitor C, and stops outputting to the load 50.

When the voltage of the power terminal V1 is larger than the first predetermined voltage, the diode D1 is being reverse breakdown. The difference in voltage of the base and the emitter of the first transistor Q1 is larger than 0.7V and the first transistor Q1 is turned on. The voltage at the first node N1 is almost 0V. The difference in voltage of the base and the emitter of the second first transistor Q2 is smaller than 0.7V and the first transistor Q1 is turned off. The difference in voltage of the source and the gate of the third transistor Q3 is equal to 0V and the third transistor Q3 is turned off. The voltage of the power terminal V1 is filtered by the capacitor C, and stops outputting to the load 50.

As described, the overvoltage protection circuit is combined with simple and separate electronic elements and is used for cutting off the electrical connection between the power supply and the load when the voltage supplied to the electronic device is larger than the predetermined value. Therefore, the overvoltage protection circuit protects the loads from being damage or destroyed by a suddenly increased in voltage.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An electronic device receiving a voltage from a power supply, the electronic device comprising:
a load;
a switching module connected between the power supply and the load; and
an overvoltage protection circuit adapted to receive the voltage;
wherein the overvoltage protection circuit comprises a control unit presetting a first predetermined voltage and an overvoltage protection unit; when the voltage generated by the power supply is larger than the first predetermined voltage, the control unit generates a protection signal to control the overvoltage protection unit to generate a first control signal, the switching module cuts off an electrical connection between the power supply and the load in response to the first control signal.

2. The electronic device of claim 1, wherein when the voltage is smaller than or equal to the first predetermined voltage, the control unit stops generating the protection signal.

3. The electronic device of claim 2, wherein the overvoltage protection unit presets a second predetermined voltage which is smaller than the first predetermined voltage; when the overvoltage protection unit does not receive the protection signal and the voltage is larger than or equal to the second predetermined voltage, the overvoltage protection unit generates a second control signal, the switching module establishes the electrical connection between the power supply and the load in response to the second control signal.

4. The electronic device of claim 2, wherein when the voltage is smaller than the second predetermined voltage, the overvoltage protection unit generates the first control signal.

5. The electronic device of claim 1, wherein the control unit comprises a diode and a first transistor; a base of the first transistor is electrically connected to the power supply through the diode, an emitter of the first transistor is grounded, a collector of the first transistor is electrically connected to the overvoltage protection unit; a cathode of the diode is electrically connected to the power supply, and an anode of the diode is electrically connected to the base of the first transistor.

6. The electronic device of claim 5, wherein the first transistor is an npn type bipolar junction transistor.

7. The electronic device of claim 1, wherein the overvoltage protection unit comprises a second transistor, a first resistor, a second resistor, and a third resistor; an end of the second resistor is grounded, the other end of the second resistor is electrically connected to the power supply through the first resistor, a base of the second transistor is electrically connected between the first resistor and the second resistor, an emitter of the second transistor is grounded, a collector of the second transistor is electrically connected to the switching module; an end of the third resistor is electrically connected to the power supply, and the other end of the third resistor is electrically connected to the drain of the second transistor.

8. The electronic device of claim 7, wherein the second transistor is an npn type bipolar junction transistor.

9. The electronic device of claim 1, wherein the switching module comprises a third transistor; a gate of the third transistor is electrically connected between the third resistor and the collector of the first transistor, a source of the third transistor is electrically connected to the power supply, a drain of the third transistor is electrically connected to the load.

10. The electronic device of claim 9, wherein the third transistor is a p-channel enhancement type metal oxide semiconductor field effect transistor.

11. The electronic device of claim 1, wherein the protection signal is a logic low level signal; and the first control signal is a logic high level signal.

12. An overvoltage protection circuit receiving a voltage from a power supply and controlling a switching module connected between the power supply and a load, the overvoltage protection circuit comprising:
a control unit presetting a first predetermined voltage; and
an overvoltage protection unit;
wherein when the voltage generated by the power supply is larger than the first predetermined voltage, the control unit generates a protection signal to control the overvoltage protection unit to generate a first control signal, the switching module cuts off an electrical connection between the power supply and the load in response to the first control signal.

13. The overvoltage protection circuit of claim 12, wherein when the voltage is smaller than or equal to the first predetermined voltage, the control unit stops generating the protection signal.

14. The overvoltage protection circuit of claim 13, wherein the overvoltage protection unit presets a second predetermined voltage which is smaller than the first predetermined voltage, when the overvoltage protection unit does not receive the protection signal and the voltage is larger than or equal to the second predetermined voltage, the overvoltage protection unit generates a second control signal, the switching module establishes the electrical connection between the power supply and the load in response to the second control signal.

15. The overvoltage protection circuit of claim 14, wherein when the voltage is smaller than the second predetermined voltage, the overvoltage protection unit generates a first control signal.

16. The overvoltage protection circuit of claim 12, wherein the control unit comprises a diode and a first transistor; a base of the first transistor is electrically connected to the power supply through the diode, an emitter of the first transistor is grounded, a collector of the first transistor is electrically connected to the overvoltage protection unit; a cathode of the diode is electrically connected to the power supply, and an anode of the diode is electrically connected to the base of the first transistor.

17. The overvoltage protection circuit of claim 16, wherein the first transistor is an npn type bipolar junction transistor.

18. The overvoltage protection circuit of claim 12, wherein the overvoltage protection unit comprises a second transistor, a first resistor, a second resistor, and a third resistor; an end of the second resistor is grounded, the other end of the second resistor is electrically connected to the power supply through the first resistor, a base of the second transistor is electrically connected between the first resistor and the second resistor, an emitter of the second transistor is grounded, a collector of the second transistor is electrically connected to the switching module; an end of the third resistor is electrically connected to the power supply, and the other end of the third resistor is electrically connected to the drain of the second transistor.

19. The overvoltage protection circuit of claim 18, wherein the second transistor is an npn type bipolar junction transistor.

20. The overvoltage protection circuit of claim 12, wherein the protection signal is a logic low level signal; and the first control signal is a logic high level signal.
